(19) United States
(12) Patent Application Publication
(10) Pub. No.: US 2012/0312251 A1
(43) Pub. Date: Dec. 13, 2012

(54) Vehicle Pet Restraint

(76) Inventor: Oparaugo I. Udebiuwa, Davidsonville, MD (US)

(21) Appl. No.: 13/154,590

(22) Filed: Jun. 7, 2011

(51) Int. Cl. B60R 22/10

(52) U.S. Cl. 119/771

(57) ABSTRACT

A vehicle pet restraint is provided for restraining an animal to a confined space and securing the animal to the vehicle for safety in the event of an accident. The pet restraint includes a frame having a pair of spaced side walls and a back wall extending between the side walls. The back wall has a pair of spaced slits configured for securing the frame to a vehicle using an existing seat belt. A strap extends between the side walls and is configured for passing through a harness loop coupled to a harness or collar. Thus, an animal in the harness or collar is secured to the frame between the spaced side walls. Alternately, a pair of straps may be employed to restrain the animal between the side walls.

### BACKGROUND OF THE DISCLOSURE

1. Field of the Disclosure

The disclosure relates to animal restraint devices and more particularly pertains to a new animal restraint device for restraining an animal to a confined space and securing the animal to the vehicle for safety in the event of an accident.

2. Summary of the Disclosure

An embodiment of the disclosure meets the needs presented above by generally comprising a frame having a pair of spaced side walls and a back wall extending between the side walls. The back wall has a pair of spaced slits configured for securing the frame to a vehicle using an existing seat belt. A strap extends between the side walls and is configured for passing through a harness loop coupled to a harness or collar. Thus, an animal in the harness or collar is secured to the frame between the spaced side walls. Alternately, a pair of straps may be employed to restrain the animal between the side walls.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a vehicle pet restraint according to an embodiment of the disclosure.

FIG. 2 is a front view of an embodiment of the disclosure.

FIG. 3 is a top view of an embodiment of the disclosure.

FIG. 4 is a back view of an embodiment of the disclosure.

FIG. 5 is a side view of an embodiment of the disclosure in use.

### DESCRIPTION OF THE PREFERRED EMBODIMENT

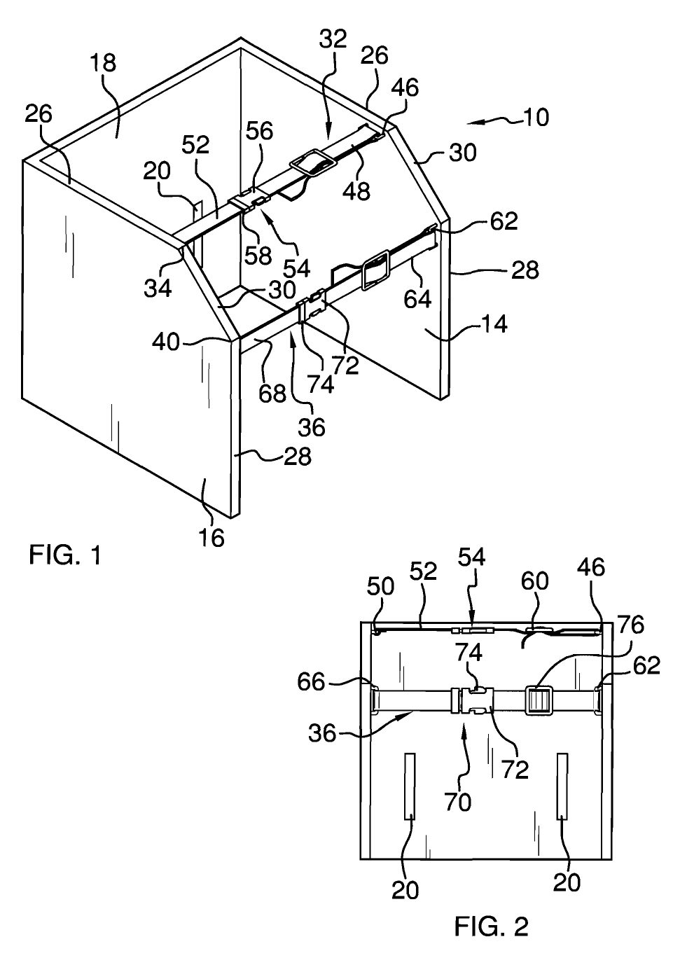

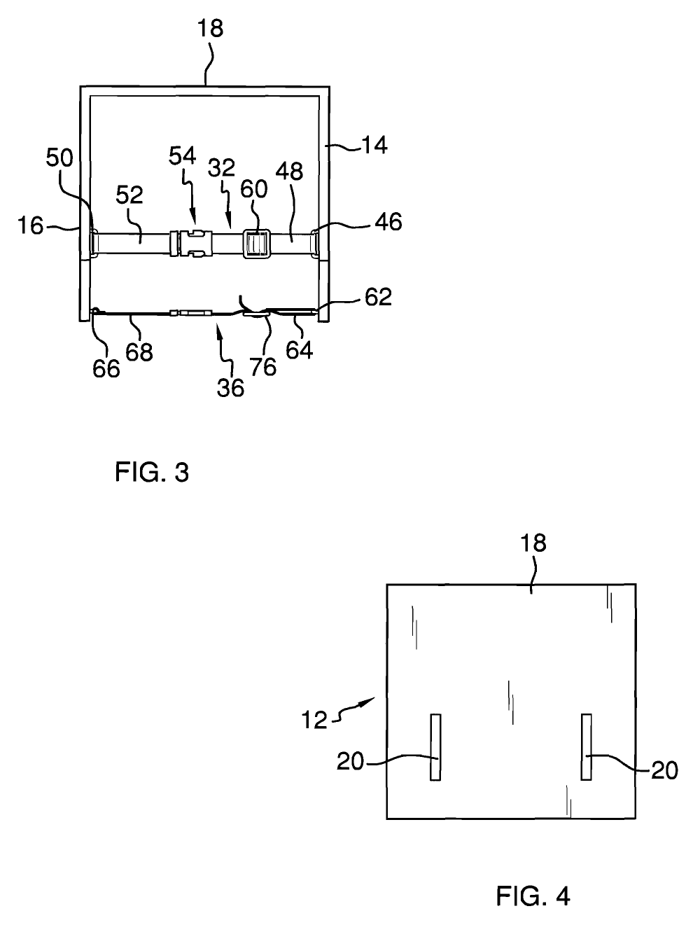

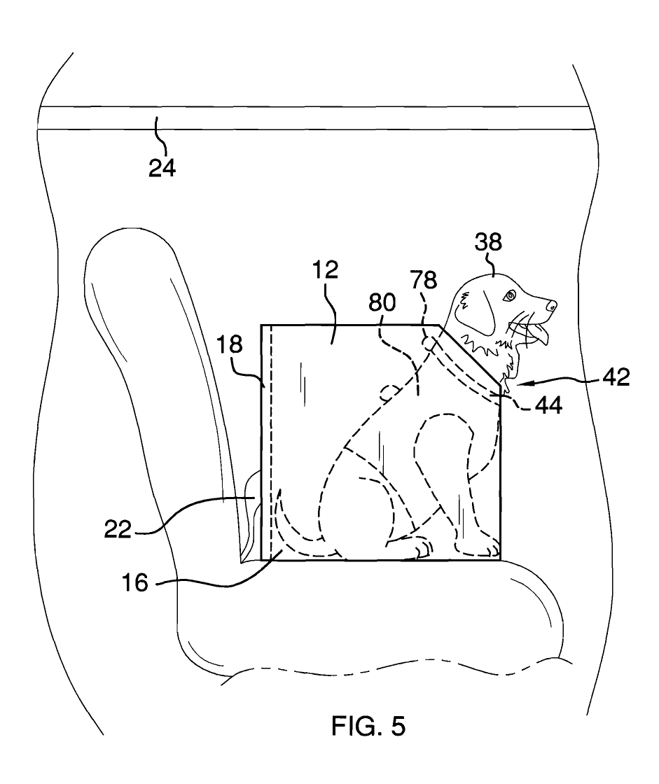

With reference now to the drawings, and in particular to FIGS. 1 through 5 thereof, a new animal restraint device embodying the principles and concepts of an embodiment of the disclosure and generally designated by the reference numeral 10 will be described.

As best illustrated in FIGS. 1 through 5, the vehicle pet restraint 10 generally comprises a frame 12 having a pair of spaced side walls 14,16 and a back wall 18 extending between the side walls 14,16. The back wall 18 has a pair of spaced vertical slits 20 configured for receiving a seat belt 22 of a vehicle 24 therethrough. Thus, the frame 12 may be secured to the vehicle 24. Each side wall 14,16 has a horizontal top edge 26 extending from the back wall 18, a vertical forward edge 28 opposite the back wall 18, and an angled edge 30 extending between the top edge 26 and the forward edge 28.

A first strap 32 extends between the side walls 14,16. The first strap 32 is positioned proximate a junction 34 between the top edge 26 and the angled edge 28 of each side wall 14,16. A second strap 36 also extends between the side walls 14,16. The second strap 36 is positioned in spaced relationship to the first strap 32. Thus, an animal 38 may be positioned between the side walls 14,16 and restrained between the side walls 14,16. The second strap 36 is positioned proximate a junction 40 between the forward edge 28 and the angled edge 30 of each side wall 14,16. The animal 38 may be positioned such that a neck 42 of the animal 38 extends between the first strap 32 and the second strap 36. Either strap 32 or 36 may be strung through a collar 44 of the animal 38 to further secure the animal 38 in place. Other strap configurations may also be employed including Y-shaped or T-shaped configurations. It is further contemplated that the first strap 32 or the second strap 36 may be used alone with the frame 12 and used to engage the collar 44 to secure the animal 38. The first strap 32 and second strap 36 are configured for passing through a harness loop 78 coupled to a harness 80 or the collar 44. Thus, the animal 38 in the harness 80 is secured to the frame 12 between said spaced side walls 14,16. The position of the first strap 32 is preferred for larger dogs and the lower second strap 36 position may be used for smaller dogs.

A first loop 46 is coupled to one of the side walls 14. The first strap 32 has a first section 48 coupled to the first loop 46. A second loop 50 is coupled to a second one of the side walls 16 opposite the first loop 46. The first strap 32 has a second section 52 coupled to the second loop 50. A first buckle assembly 54 has a first portion 56 coupled to the first section 48 of the first strap 32 and a second portion 58 coupled to the second section 52 of the first strap 32. The first portion 56 of the first buckle assembly 54 is couplable to the second portion 58 of the first buckle assembly 54. Thus, the first section 48 of the first strap 32 is coupled to the second section 52 of the first strap 32 as desired. A first slide buckle 60 is coupled to the first section 48 of the first strap 32. Thus, a length of the first section 48 of the first strap 32 is adjustable as desired.

A first ring 62 is coupled to one of the side walls 14. The second strap 36 has a first section 64 coupled to the first ring 62. A second ring 66 is coupled to a second one of the side walls 16 opposite the first ring 62. The second strap 36 has a second section 68 coupled to the second ring 66. A second buckle assembly 70 has a first portion 72 coupled to the first section 64 of the second strap 36 and a second portion 74 coupled to the second section 68 of the second strap 36. The first portion 72 of the second buckle assembly 70 is couplable to the second portion 74 of the second buckle assembly 70. Thus, the first section 64 of the second strap 36 is coupled to the second section 68 of the second strap 36 as desired. A second slide buckle 76 is coupled to the first section 64 of the second strap 36. Thus, a length of the first section 64 of the second strap 36 is adjustable.

In use, the frame 12 is secured to the vehicle 24 by passing the seat belt 22 of the vehicle 24 through the slits 20 in the same manner some children's car seats are known to be secured. The animal 38 is positioned in front of the back wall 18 and between the side walls 14,16. The first strap 32 and second strap 36 are adjusted to prevent the animal 38 from moving inside the vehicle 24. This may include unbuckling either the first buckle assembly 54 or the second buckle assembly 70 and inserting the first strap 32 or the second strap 36 through hardware on the animal's collar to hold the animal 38 in place. The frame 12 is lightweight and may be constructed of durable plastic material. The absence of a floor panel extending between the side walls 14,16 allows the animal 38 to sit comfortably on the vehicle's seat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A vehicle animal restraint assembly comprising:
a frame having a pair of spaced side walls and a back wall extending between said side walls, said back wall having a pair of spaced slits configured for receiving a seat belt of a vehicle therethrough whereby said frame is secured to the vehicle; and
a strap extending between said side walls, said strap being configured for passing through a harness loop coupled to a harness whereby an animal in the harness is secured to said frame between said spaced side walls.

2. The assembly of claim 1, wherein each said side wall has a horizontal top edge extending from said back wall, a vertical forward edge opposite said back wall, and an angled edge extending between said top edge and said forward edge.

3. The assembly of claim 2, wherein said strap is positioned proximate a junction between said top edge and said angled edge.

4. The assembly of claim 2, wherein said strap is positioned proximate a junction between said forward edge and said angled edge.

5. The assembly of claim 1, further comprising:
a first loop coupled to one of said side walls;
a second loop coupled to a second one of said side walls opposite said first loop;
said strap having a first section coupled to said first loop;
said strap having a second section coupled to said second loop; and
a buckle assembly having a first portion coupled to said first section of said strap and a second portion coupled to said second section of said strap, said first portion of said buckle assembly being couplable to said second portion of said buckle assembly whereby said first section of said strap is coupled to said second section of said strap.

6. The assembly of claim 5, further including a slide buckle coupled to said first section of said strap.

7. A vehicle animal restraint assembly comprising:
a frame having a pair of spaced side walls and a back wall extending between said side walls, said back wall having a pair of spaced slits configured for receiving a seat belt of a vehicle therethrough whereby said frame is secured to the vehicle; and
a first strap extending between said side walls; and
a second strap extending between said side walls, said second strap being positioned in spaced relationship to said first strap whereby an animal positioned between said side walls is restrained between said side walls.

8. The assembly of claim 7, wherein each said side wall has a horizontal top edge extending from said back wall, a vertical forward edge opposite said back wall, and an angled edge extending between said top edge and said forward edge.

9. The assembly of claim 8, wherein said first strap is positioned proximate a junction between said top edge and said angled edge.

10. The assembly of claim 8, wherein said second strap is positioned proximate a junction between said forward edge and said angled edge.

11. The assembly of claim 7, further comprising:
a first loop coupled to one of said side walls;
a second loop coupled to a second one of said side walls opposite said first loop;
said first strap having a first section coupled to said first loop;
said first strap having a second section coupled to said second loop; and
a first buckle assembly having a first portion coupled to said first section of said first strap and a second portion coupled to said second section of said first strap, said first portion of said first buckle assembly being couplable to said second portion of said first buckle assembly whereby said first section of said first strap is coupled to said second section of said first strap.

12. The assembly of claim 11, further including a first slide buckle coupled to said first section of said first strap.

13. The assembly of claim 11, further comprising:
a first ring coupled to one of said side walls;
a second ring coupled to a second one of said side walls opposite said first ring;
said second strap having a first section coupled to said first ring;
said second strap having a second section coupled to said second ring; and
a second buckle assembly having a first portion coupled to said first section of said second strap and a second portion coupled to said second section of said second strap, said first portion of said second buckle assembly being couplable to said second portion of said second buckle assembly whereby said first section of said second strap is coupled to said second section of said second strap.

14. The assembly of claim 13, further including a second slide buckle coupled to said first section of said second strap.

15. A vehicle animal restraint assembly comprising:
a frame having a pair of spaced side walls and a back wall extending between said side walls, said back wall having a pair of spaced vertical slits configured for receiving a seat belt of a vehicle therethrough whereby said frame is secured to the vehicle, wherein each said side wall has a horizontal top edge extending from said back wall, a vertical forward edge opposite said back wall, and an angled edge extending between said top edge and said forward edge;
a first strap extending between said side walls, wherein said first strap is positioned proximate a junction between said top edge and said angled edge;
a second strap extending between said side walls, said second strap being positioned in spaced relationship to said first strap whereby an animal positioned between said side walls is restrained between said side walls, wherein said second strap is positioned proximate a junction between said forward edge and said angled edge;
a first loop coupled to one of said side walls, said first strap having a first section coupled to said first loop;
a second loop coupled to a second one of said side walls opposite said first loop, said first strap having a second section coupled to said second loop;
a first buckle assembly having a first portion coupled to said first section of said first strap and a second portion coupled to said second section of said first strap, said first portion of said first buckle assembly being couplable to said second portion of said first buckle assembly whereby said first section of said first strap is coupled to said second section of said first strap;
a first slide buckle coupled to said first section of said first strap;
a first ring coupled to one of said side walls, said second strap having a first section coupled to said first ring;
a second ring coupled to a second one of said side walls opposite said first ring, said second strap having a second section coupled to said second ring;
a second buckle assembly having a first portion coupled to said first section of said second strap and a second portion coupled to said second section of said second strap, said first portion of said second buckle assembly being couplable to said second portion of said second buckle assembly whereby said first section of said second strap is coupled to said second section of said second strap; and
a second slide buckle coupled to said first section of said second strap.
